(19) United States
(12) Patent Application Publication
(10) Pub. No.: US 2026/0094584 A1
(43) Pub. Date: Apr. 2, 2026

(54) DRUMSTICK

(71) Applicant: Daniel Klug, Milford, CT (US)

(72) Inventor: Daniel Klug, Milford, CT (US)

(21) Appl. No.: 18/898,941

(22) Filed: Sep. 27, 2024

(51) Int. Cl. G10D 13/12

(52) U.S. Cl. CPC G10D 13/12

(57) ABSTRACT

A drumstick comprising different parts each having its own dimension and qualities. The drumstick has a largely typical handle and an arm connected to the handle via a coupler. The arm is thinner and made of more flexible material than the handle.

### FIELD OF THE INVENTION

The present disclosure is directed to percussion instruments. Specifically, the invention relates to drumsticks.

### BACKGROUND OF THE INVENTION

Drumsticks traditionally are created as unitary solid pieces of material. Most drumsticks on the market are about sixteen inches long and made of strong, durable wood like hickory that will rebound naturally when the stick strikes a surface. There are many different thicknesses to drumsticks. Sticks range from thinner and lighter to thicker and heavier depending on a drummer's intention. Drummers select drumsticks based on a size that they find suitable for them and the music they are playing. Many of the prior art drumsticks are made to have weight as they are solid and made to add weight as a user strikes a drum, for instance. Solid drumsticks made of wood and similar heavy or dense materials are not conducive to practicing nor do such sticks enhance the users technique.

Variations to drumsticks include those that don't use a single piece of wood for the whole body of the stick and instead utilize multiple pieces of different materials to reach different desired effects. The most common desired effect with those models is to produce a lower decibel sound when striking a surface compared to a typical, solid, unitary and inflexible drumstick.

Typically, these drumsticks are designed by attaching a handle to several thinner pieces of various materials or by wrapping several pieces of various materials tightly together. Materials in these designs can range from plastics, metals, wood, wood composites, fiberglass, etc.

Regardless of design, the desired effect of any drumstick on the market is to produce different sounds when a drummer uses the stick to strike a surface. The design and structure of the drumstick will impact the sound produced.

The disadvantage of the drumsticks on the market today is that due to their uniform design and structure, there are limited ways to practice the instrument other than repeating exercises, rudiments, over and over again at increasingly faster tempos with increasingly heavier drumsticks. While this approach will build strength, speed, stamina and focus over time, there are no drumsticks on the market that are intended for practice use that can enable drummers to build strength, speed, stamina and focus on a shorter time frame.

What is desired is a drumstick that is useful as a practice device. What is desired is a drumstick that allows the user to be challenged to get the stick to go where they want it to go. What is desired is a drumstick that allows a user to build strength, speed, stamina, precision and focus. What is desired is a drumstick that, when used, allows a user to increase their drumming skills in less time than other drumsticks can. What is desired is a drumstick that has a traditional handle. What is desired is a drumstick that has an arm that differs from the handle. What is desired is a drumstick that has an arm that differs from the handle in dimension and weight. What is desired is a drumstick where the arm is thinner than the handle. What is desired is a drumstick where the arm is bendable and will not break when played.

### SUMMARY OF THE INVENTION

The drumstick has a handle, an arm and a coupler disposed between the arm and the handle. The handle is shorter, wider and taller than arm. The densities between the handle and the arm differ wherein the handle is inflexible, and the arm is flexible. In one embodiment, the arm may be centered on the center of the handle. In another embodiment, the arm may be off-centered to the end of the handle.

### DESCRIPTION OF THE DRAWINGS

FIG. 1A is an elevational view of a drumstick according to one embodiment of the invention.

FIG. 1B shows a top view of the drumstick in FIG. 1A.

FIG. 1C shows a side view of the drumstick in FIG. 1A.

FIG. 2A is an elevational view of a drumstick according to a second embodiment of the invention.

FIG. 2B shows a top view of the drumstick in FIG. 2A.

FIG. 2C shows a side view of the drumstick in FIG. 2A.

### DETAILED DESCRIPTION OF THE INVENTION

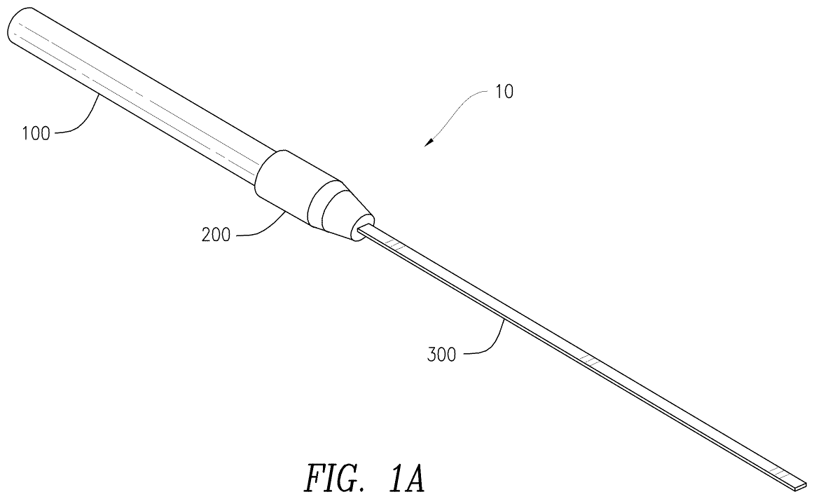

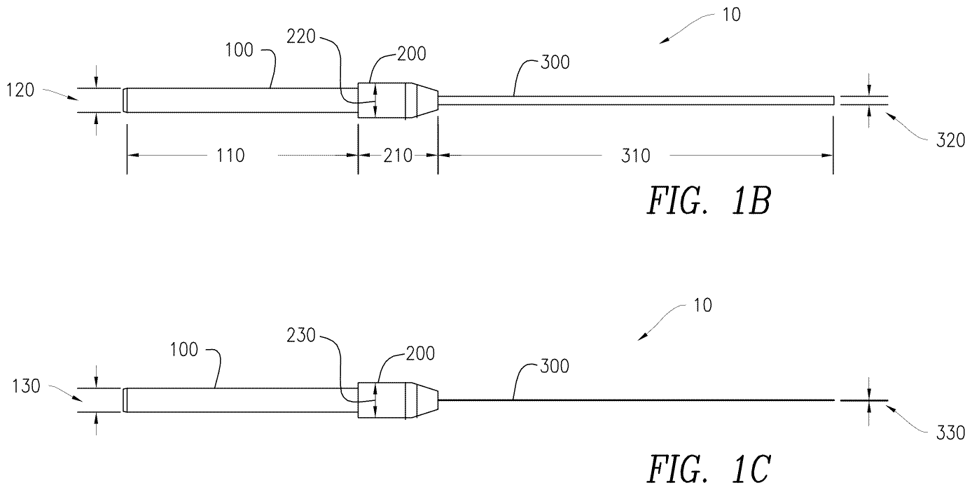

FIG. 1A shows a drumstick 10 of a first embodiment having a handle 100, a coupler 200, and an arm 300. The arm 300 is coupled to the handle 100, via the coupler 200 that facilitates a secure bond between the two. The handle 100 and the arm 300 have different densities. The handle is inflexible and weighs more than the arm 300. The arm 300 is flexible and thinner than the handle 100 and will bend but not break while in use.

FIGS. 1B and 1C, show the top and side views of the drumstick 10, respectively. As seen in the figures, the drumstick 10 has a long flat arm 300. When comparing the top and side views, FIGS. 1B and 1C, it is apparent that the arm 300 is thinner than the handle 100. The handle 100 has a perimeter or circumference and diameter, a handle length 110, a handle width 120 and a handle height 130. The arm 300 has an arm length 310, an arm width 320 and an arm height 330. In one embodiment, the handle length 110 is shorter than the arm length 310. In another embodiment, the handle width 120 is larger or wider than the arm width 320 and the handle height 130 is larger than the arm height 330. The coupler 200 has a length 210, a width 220 and a height 320. In the embodiment of FIGS. 1A to 1C, one end of the coupler 200 receives, is disposed, an end of the handle 100 and a second end of the coupler 200 receives, is disposed, an end of the arm 300. The arm 300 is centered on the end of the handle 100; specifically, the coupler 200 lands the arm 300 approximately in a center of a diameter of the handle 100. Said another way, the arm 300 is centered in a circumference of the handle 100.

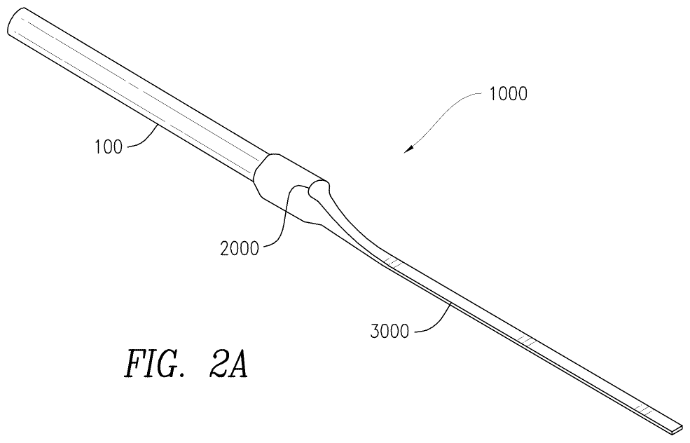

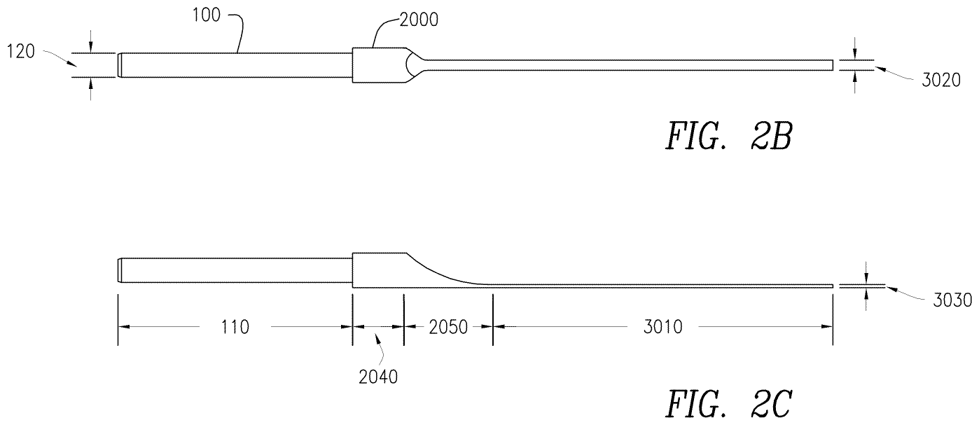

Drumstick 1000 is shown as a second embodiment in FIG. 2A. Many qualities of drumstick 10 are found in drumstick 1000. Here the handle 100 is the same and uses a coupler 2000, and an arm 3000. The coupler 2000 has a wide end 2040 that receives, at which is disposed, an end of the handle 100 and a tapered end 2050 that, in one embodiment, extends into the arm 3000. The coupler 2000 here too facilitates a secure bond between the arm 3000 and the handle 100.

The handle 100 and the arm 3000 have different densities. Here, the arm 3000 is off-centered, disposed at an edge of the handle 100. Said another way, the arm 3000 is disposed at the perimeter on a circumference of the handle 100. Each the handle 100 and the coupler 2000 has a circumference and the arm 3000 is disposed on an edge of the circumference or perimeter of either or both the handle 100 and the coupler. The coupler 2000 attaches the arm 3000 to the perimeter of the coupler 2000, which lands the arm 3000 parallel with a side of the handle 100. In some embodiments, the coupler 2000 and the arm 3000 are a single unit where the arm tapers from the perimeter of the coupler 2000.

In operation, a user holds the handle 100 of the drumstick 10, 1000 in each hand and moves their forearms, wrists, hands and fingers to bring the drumstick 10, 1000 up and down or sometimes side to side so a tip the arm 300, 3000 of the drumstick 10, 1000 strikes a surface.

The flexible nature of the drumstick 10, 1000, requires the user to approach their grip differently than a prior art drumstick. The drumstick 10, 1000 challenges a user to use muscles in their fingers, hands, wrists and forearms differently than they would using the same muscles when holding a prior art drumstick. A user will need to tighten their grip in their hands and fingers and increase torque in their wrist and forearms, building strength, speed, precision and concentration to get the stick to go where they want it to go.

In one embodiment, the arm 300 is flexible and may take the form of a thin, cubed rectangle. The arm 300, 3000 has a height 330, 3030 providing thin sides and width 320, 3020, respectively. The arm width 320, 3020 serves as a striking surface of the drumstick 10, 1000. If the user's grip loosens while playing, the drumstick 10, 1000 will rotate and the thin sides, or the height 330, 3030, of the arm 300 will become a striking surface, causing the user to feel slight discomfort in not using the correct playing position and indicating to the user to revert back to a correct holding posture.

The drumstick 10, 1000 may be made of any material. For instance, the handle 100 may be made of wood however, other materials may also be used at the handle 100 like plastic, fiberglass, wood composite or other metals, and the like that provide a weight. The arm 300, 3000 may be made of plastic but other materials like wood, fiberglass, wood composite or other metals, etc. will suffice.

In one embodiment, the handle 100 may have a length of between 100 mm to 200 mm, in on preferred embodiment the handle may be 130 mm. The coupler 200 may have a length between of 30 mm and 55 mm, in a preferred embodiment, the length may be 45 mm. The coupler 2000 may have a length of about 100 mm and in a preferred embodiment a wide end 2040 has a length of about 29.1 mm and a tapering end 2050 has about a length of 49.07 mm. In one embodiment, the coupler 2000 may be 78.17 mm in length. The arm 300, 3000 may have a width of about 6.0 mm and about a height of about 0.8 mm. The arm 300 may have a length of about 225 mm and the arm 3000 may have a length of about 191.83 mm. However, all measurements are just embodiments and other dimensions are feasible to achieve the present invention.

As the drumstick is partially flexible, the user will need to use more energy and strength in their hands, fingers, wrists and forearms as well as more mental focus to get the stick to where they want it to go. In use, the drumstick allows a user to practice drum strokes to increase their strength, speed, focus and precision while practicing drums. Regular use of the drumstick allows a drummer to gain strength, focus and precision in play compared to using prior art drumsticks.

While specific embodiments of the invention have been described and illustrated, such embodiments should be considered illustrative of the invention only and not as limiting the invention as construed in accordance with the accompanying claims. One of ordinary skill in the art could alter the above embodiments or provide insubstantial changes that may be made without departing from the scope of the invention.

I claim:

1. A drumstick comprising:
a handle, the handle having a handle length, a handle width and a handle height, said handle having a handle density; and
an arm, the arm coupled to the handle, the arm having an arm length, an arm width and an arm height, said arm having an arm density;
wherein the handle density is different from the arm density.

2. The drumstick of claim 1, wherein the handle length differs from the arm length.

3. The drumstick of claim 1, wherein the handle length is shorter than the arm length.

4. The drumstick of claim 1, wherein the handle width is larger than the arm width.

5. The drumstick of claim 1, wherein the handle height differs from the arm height.

6. The drumstick of claim 1, wherein the handle height is larger than the arm height.

7. The drumstick of claim 1, wherein the arm width is larger than the arm height.

8. The drumstick of claim 1, wherein the handle is inflexible.

9. The drumstick of claim 1, wherein the arm is flexible.

10. The drumstick of claim 1, wherein the arm is centered on an end of the handle.

11. The drumstick of claim 1, wherein the arm is centered on a diameter of the handle.

12. The drumstick of claim 1, wherein the arm is centered in a circumference of the handle.

13. The drumstick of claim 1, wherein the arm is off-center to an end of the handle.

14. The drumstick of claim 13, wherein the arm is disposed at an edge of the handle.

15. The drumstick of claim 1, wherein the arm is disposed at a perimeter on a circumference of the handle.

16. The drumstick of claim 1, further comprising a coupler, wherein the coupler is disposed between and connects the arm and the handle.

17. The drumstick of claim 1, wherein the handle is made of different material than the arm.

18. The drumstick of claim 1, wherein the arm width is a striking surface.
